(19) United States
(12) Patent Application Publication
(10) Pub. No.: US 2008/0085467 A1
(43) Pub. Date: Apr. 10, 2008

(54) PHOTOSENSITIVE MATERIAL AND OPTICAL RECORDING MEDIUM USING THE SAME

(75) Inventors: Norikatsu Sasao, Tokyo (JP); Kazuki Matsumoto, Kawasaki-Shi (JP); Akiko Hirao, Kawasaki-Shi (JP); Rumiko Hayase, Yokohama-Shi (JP); Takahiro Kamikawa, Kawasaki-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/867,304

(22) Filed: Oct. 4, 2007

(30) Foreign Application Priority Data
Oct. 6, 2006 (JP) 2006-275104

(51) Int. Cl. G11B 7/241

(52) U.S. Cl. 430/270.11

(57) ABSTRACT

The present invention relates to a powdery photosensitive material comprising evenly dispersed components and free from a variation in quality, and an optical recording medium produced from the photosensitive material. The photosensitive material is produced by a process including freezing a solution of components that constitutes the photosensitive material dissolved in a first solvent and then drying the resultant solid under reduced-pressure.

### CROSS-REFERENCE TO RELATED APPLICATIONS

This application is based upon and claims the benefit of priority from the prior Japanese Patent Application No. 2006-275104, filed on Oct. 6, 2006; the entire contents of which are incorporated herein by reference.

### BACKGROUND OF THE INVENTION

The invention relates to a process for manufacturing a powdery photosensitive material, a photosensitive material, and an optical recording medium manufactured from the photosensitive material.

One of the applications of the photosensitive material is holographic recording media. Holographic memory that holds data in a form of holography is capable to record data in high capacity. Much attention has been paid on the development of such material that enables to record data holographically. Such materials include Omnidex [registered trademark, DuPont Company] which is one type of photosensitive polymer film (photopolymer). In this case, a photoactive monomer, a photoinitiator and a sensitizing dye are well dispersed throughout a thermoplastic binder to form a photopolymer. When interference pattern is exposed on to the photopolymer, the photoinitiator at a high optical field, i.e., at a bright region, decomposes to give initiating radicals, which initiate radical polymerization. Because the photoactive monomers diffuse from the dark regions to the bright regions, further polymerization in the bright regions is promoted to give polymers with high molecular weight. This leads to disparity in density and in refractive index between the bright regions and the dark regions in the photopolymer. The disparity follows the profile of the interference pattern that has been exposed, and this is how hologram is recorded.

One of the methods to manufacture such holographic recording media is by dissolving the components of the media to a solvent to form a precursor solution of a holographic recording media. The solution is then spread on to a transparent substrate such as glass substrate by means of spin coating, dip coating or the like (JP-A 2006-3388 (Kokai)). However, it is difficult to remove the solvent completely out from the solution that had been spread on the substrate, and thus, this manufacturing technique has a problem that the solvent remains unremoved in the recording layer. Due to such problem, the components in the recording layer are unevenly distributed throughout the recording layer; one finds the components at higher concentration in and around the residual solvent than the other region. Accordingly, it has been difficult to bring about an even distribution of reactive components in the recording layer throughout the media. This uneven distribution of the components has led to a fluctuation in properties of the medium from position to position.

In order to avoid the problem described above, one can manufacture the recording medium without using any solvent. Each one of the components that are dry are ground and mixed together to prepare a powdery mixture which is then pressed. However, in this method, the sizes of the grains of the components after the grinding differs, and when the powdery mixture is placed in a mold in the pressing machine, the component with smaller grain-size is unevenly distributed in the lower layer while the component with larger grain-size is unevenly distributed in the upper layer. Thus, also in this method, it is not easy to prepare a recording medium in which the individual components are evenly distributed.

### BRIEF SUMMARY OF THE INVENTION

The invention relates to a process of manufacturing a powdery photosensitive material, including: freezing a solution of components that constitutes the photosensitive material that are dissolved in a first solvent, thereby obtaining a solid composition; and drying the resultant solid composition under reduced pressure to obtain a powdery photosensitive material.

### DETAILED DESCRIPTION OF THE INVENTION

Hereinafter, embodiments of the invention will be described in detail. Here a description will be given particularly on a holographic recording medium.

<Powdery Photosensitive Material>

The process for manufacturing a powdery photosensitive material according to the present invention includes the steps of: freezing a solution of components that constitutes the photosensitive material that are dissolved in a first solvent, thereby obtaining a solid composition; and drying the resultant solid composition under reduced pressure.

A polymeric matrix, a photoinitiator, a monomer and the like may be mentioned as components that constitutes the photosensitive material according to the present invention.

In addition to the above components, other components such as plasticizers, sensitizing dyes, inhibitors, and chain transfer agents may be added into the photosensitive material, if necessary.

In a preferred embodiment of the process for manufacturing a powdery photosensitive material according to the present invention, the freezing of the solution is carried out by spraying the solution into a chamber cooled to a temperature below the freezing point of the solution.

In a preferred embodiment of the process for manufacturing a powdery photosensitive material according to the present invention, the first solvent has a freezing point in the range of −100° C. to +100° C.

In a preferred embodiment of the process for manufacturing a powdery photosensitive material according to the present invention, the first solvent is selected from the group consisting of water, acetamide, trioxane, acetic acid, p-xylene, 1,4-dioxane, 2-aminoethanol, formic acid, cyclohexane, benzene, morpholine, aniline, nitromethane, piperidine, nitromethane, anisole, pyridine, and acetonitrile.

In a preferred embodiment of the process for manufacturing a powdery photosensitive material according to the present invention, the components that constitutes the photosensitive material are a polymer, a photoinitiator, and a monomer.

In a preferred embodiment of the process for manufacturing a powdery photosensitive material according to the present invention, the freezing of the solution is carried out in the copresence of a second solvent which has been mixed into the solution before freezing the solution.

In a preferred embodiment of the process for manufacturing a powdery photosensitive material according to the present invention, the freezing of the solution is carried out by the heat of the vaporization of the second solvent.

In a preferred embodiment of the process for manufacturing a powdery photosensitive material according to the present invention, the solubility of the components that constitutes the photosensitive material to the second solvent is lower than that of the first solvent.

In a preferred embodiment of the process for manufacturing a powdery photosensitive material according to the present invention, the second solvent has a freezing point below the first solvent.

In a preferred embodiment of the process for manufacturing a powdery photosensitive material according to the present invention, the second solvent has a vapor pressure above the first solvent.

According to the present invention the powdery photosensitive material manufactured by the process above, the content of the remaining solvent in the powdery photosensitive material is 10 ppm or less.

According to the present invention, there is also provided an optical recording medium manufactured from the powdery photosensitive material stated above.

In a preferred embodiment of the optical recording medium according to the present invention, the optical recording medium is manufactured by press molding the powdery photosensitive material stated above.

In a preferred embodiment of the optical recording medium according to the present invention, the optical recording medium is manufactured by press molding the powdery photosensitive material stated above at or above the glass transition temperature of the photosensitive material.

According to the present invention, the components that constitutes the photosensitive material is dispersed evenly, densely and finely without uneven distribution.

By virtue of the advantage stated above, the photosensitive layer formed of the photosensitive material obtained from the powdery photosensitive material according to the present invention, variation in properties is small even when the area and thickness of the photosensitive material are large. This enables the photosensitive material to react without fluctuation from position to position. Therefore, the powdery photosensitive material is particularly suitable for photosensitive material, such as the recording layer in optical recoding media.

Furthermore, the powdery photosensitive material according to the invention is also advantageous in that it can be molded to form a molded product in a short time by means of press molding and the like.

In particular, since the photosensitive material to be pressed is powdery and has a very low residual solvent content volume shrinkage that derives from the evaporation of the solvent does not occur. This enables to fabricate a molded product to a desired shape, thickness and surface flatness with great accuracy and also within a short time. In the press molding process, one can raise the temperature up to the melting point of the photosensitive material. Since each of the components that constitutes the photosensitive material are dispersed evenly, densely and finely, melting the polymer forms the polymeric matrix rapidly and evenly. Therefore, it is unlikely that one part of the composition is heated to an excessively elevated temperature, nor is it that the composition is subjected to melting and kneading treatment for a long period of time. The prevention of the composition from such harch treatment enables the photosensitive material to maintain its original properties.

Polymer Component

The polymeric material component in the photosensitive material according to the present invention mainly constitutes a matrix where a photoinitiator and a monomer are dispersed therein. The photosensitive material, such as the recording layer of an optical recording media, is formed from the powdery photosensitive material according to the present invention.

Such polymers that form the polymeric matrix according to the present invention include polymethacrylic esters or polymethacrylic esters that are partially hydrolyzed, polyvinyl acetate or its partially hydrolyzed product, polyvinyl alcohol or its partially acetalized product, triacetylcellulose, polyisobutylene, polybutadiene, polychloroprene, silicone rubber, polystyrene, polyvinylbutyral, polychloroprene, polyvinyl chloride, polyallylate, chlorinated polyethylene, chlorinated polypropylene, poly-N-vinylcarbazole or its derivatives, poly-N-vinylpyrrolidone or its derivatives, polyallylate, a copolymer of styrene with maleic anhydride or its semiester, and a copolymer using, as a comonomer, at least one of the groups of copolymerizable monomers, for example, acrylic acid, acrylic ester, methacrylic acid, methacrylic ester, acrylamide, acrylonitrile, ethylene, propylene, vinyl chloride, and vinyl acetate, or their mixtures.

Among the polymers stated above, polymers having a glass transition temperature below or equal to room temperature are preferred. Polybutyl methacrylate, polypropylene, polyethylene oxide, polybutadiene and the like are particularly preferred.

Monomer Component

Monomers having at least one ethylenic unsaturated bond include, for example, an unsaturated carboxylic acid, an unsaturated carboxylic acid ester, an unsaturated carboxylic acid amide, and a vinyl compound. More specifically, examples of the photoactive monomers include acrylic acid, methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, 2,4,6-tribromophenyl acrylate, isobornyl acrylate, adamantyl acrylate, methacrylic acid, methyl methacrylate, propyl methacrylate, butyl methacrylate, phenyl methacrylate, phenoxyethyl acrylate, chlorophenyl acrylate, adamantyl methacrylate, isobornyl methacrylate, N-methylacrylamide, N,N-dimethylacrylamide, N,N-methylene bisacrylamide, acryloylmorpholine, vinylpyridine, styrene, bromostyrene, chlorostyrene, tribromophenyl acrylate, trichlorophenyl acrylate, tribromophenyl methacrylate, trichlorophenyl methacrylate, vinylbenzoate, 3,5-dichlorovinylbenzoate, vinylnaphthalene, vinyl naphthoate, naphthyl methacrylate, naphthyl acrylate, N-phenyl methacrylamide, N-phenylacrylamide, N-vinylpyrrolidinone, N-vinylcarbazole, 1-vinylimidazole, bicyclopentenyl acrylate, 1,6-hexanediol diacrylate, pentaerythritol triacrylate, pentaerythritol tetraacrylate, dipentaerythritol hexaacrylate, diethylene glycol diacrylate, polyethylene glycol diacrylate, polyethylene glycol dimethacrylate, tripropylene glycol diacrylate, propylene glycol trimethacrylate, diallyl phthalate, and triallyl trimellitate.

The monomer is preferably solid at room temperature and is particularly preferarble that the monomer is substantially not sublimable in each step of the production of the powdery photosensitive material and the optical recording medium according to the present invention. Specific examples of such preferred monomers include 2,4,6-tribromophenyl acrylate and N-vinylcarbazole.

The amount of the monomer incorporated in the photosensitive material is preferably not less than 1% by weight and not more than 50% by weight, particularly preferably not less than 1% by weight and not more than 30% by weight of the total photosensitive material that constitutes the recording layer of the optical recording media. Sufficient disparity in the refractive index can be achieved if the having the amount of the monomer more or equal to 1% by weight. Volume shrinkage can be made little having the amount of monomer less or equal to 50% by weight. Small volume shrinkage leads to a high resolution of the reconstructed image.

Photoinitiator Component

Photoinitiator can roughly be classified into photoradical polymerization initiators and photocation polymerization initiators. The photoinitiator in the present invention is preferably solid at room temperature and, at the same time, is preferarble that the photoinitiator is substantially not sublimable in each step of the production of the powdery photosensitive material and the optical recording medium according to the present invention.

The photoinitiator is selected in accordance with the wavelength of a recording beam. Examples of the photoinitiators include benzoin ether, benzyl ketal, benzyl, acetophenone derivatives, aminoacetophenones, benzophenone derivatives, acyl phosphine oxides, triazines, imidazole derivatives, organic azide compounds, titanocenes, organic peroxides, and thioxanthone derivatives. More specifically, examples of the photoinitiator include benzyl, benzoin, benzoin ethyl ether, benzoin isopropyl ether, benzoin butyl ether, benzoin isobutyl ether, 1-hydroxycyclohexyl phenyl ketone, benzyl methyl ketal, benzyl ethyl ketal, benzyl methoxyethyl ether, 2,2′-diethylacetophenone, 2,2′-dipropylacetophenone, 2-hydroxy-2-methylpropiophenone, p-tert-butyltrichloroacetophenone, thioxanthone, 1-chlorothioxanthone, 2-chlorothioxanthone, 2-methylthioxanthone, 2-isopropylthioxanthone, 3,3′,4,4′-tetra(t-butylperoxycarbonyl)benzophenone, 2,4,6-tris(trichloromethyl)-1,3,5-triazine, 2-(p-methoxyphenyl)-4,6-bis(trichloromethyl)-1,3,5-triazine, 2-[(p-methoxyphenyl)ethylene]-4,6-bis(trichloromethyl)-1,3,5-triazine, diphenyl-(2,4,6-trimethylbenzoyl)phosphine oxide, Irgacure [registered trademark] 149, 184, 369, 651, 784, 819, 907, 1700, 1800, 1850, and so forth, available from Ciba Specialty Chemicals, di-t-butyl peroxide, dicumyl peroxide, t-butyl cumyl peroxide, t-butyl peroxyacetate, t-butyl peroxyphthalate, t-butyl peroxybenzoate, acetyl peroxide, isobutyryl peroxide, decanoyl peroxide, lauroyl peroxide, benzoyl peroxide, t-butyl hydroperoxide, cumene hydroperoxide, methyl ethyl ketone peroxide, and cyclohexanone peroxide. A titanocene compound such as Irgacure [registered trademark] 784 (Ciba Specialty Chemicals) is preferable for the photoinitiator when a blue laser beam is used for recording.

The photocation initiator may also be selected depending upon the application of the photosensitive material and the selected monomer. In the present invention, preferred photocation initiators include aromatic diazonium salts, aromatic idonium salts, aromatic phosphonium salts, and mixed coordinated metal salts.

The amount of the photoinitiator is preferably 0.1 to 20% by weight, more preferably 0.2 to 10% by weight of the total photosensitive material that constitutes the recording layer of the optical recording media. Having the amount of the photoinitiator 0.1 wt % or more, sufficient disparity in the refractive index can be achieved. When the amount of the photoinitiator is 20 wt % or less, light absorption would be small enough to achieve high sensitivity and high diffraction efficiency.

Other Components

In addition to the components stated above, one can add plasticizers, sensitizing dyes, inhibitors, and chain transfer agents, if necessary. Preferred plasticizers include, for example, tributyl phosphite and propionamide. Preferred sensitizing dyes include, for example, cyanine, merocyanine, xanthene, coumarin, and eosin.

### MANUFACTURING PROCESS

### First Embodiment

The process for manufacturing a powdery photosensitive material according to the first embodiment of the present invention comprises the steps of: freezing a solution of components for that constitutes the photosensitive material dissolved in a first solvent; and drying the resultant solid under reduced pressure.

In the present invention, the components that constitute the photosensitive material (that is, the polymeric matrix component the photoinitiator component, the monomer component, and the other components) are dissolved in a first solvent to provide a homogeneous solution. Here the concentration of the solution in which each of the components are dissolved in, is preferably to be as low as possible so that the components would be well-dispersed as will described later. However, when the concentration of the solution is excessively low, the amount of the solvent needed gets very large. In such a case, the cost for the solvent and the energy to remove the solvent increases. For such reasons, the amount of the polymer component (dried state) dissolved in the solvent is preferably not less than 0.01% by weight and not more than 1% by weight, more preferably not less than 0.01% by weight and not more than 0.5% by weight.

It is essential that the first solvent used in the present invention can dissolve each of the above components (that is, a polymer, a photoinitiator and a monomer. It also includes other components which are optionally added.) to form the photosensitive material according to the present invention.

Preferably, the first solvent has a melting point in the range of −100° C. to +100° C. When the melting point is below the lower limit of the melting point range stated above, freezing the solution becomes difficult. On the other hand, when the melting point is above 100° C., heating is required. This heating is likely to cause any reaction of the reactive components in the medium. Specific examples of the preferable first solvents include water, acetamide, trioxane, acetic acid, p-xylene, 1,4-dioxane, 2-aminoethanol, formic acid, cyclohexane, benzene, morpholine, aniline, nitromethane, piperidine, nitromethane, anisole, pyridine, and acetonitrile. Specific examples of particularly preferred first solvents include water, 1,4-dioxane, and benzene. The solvents stated above may be used either solely or in a combination of two or more.

In the present invention, the solvent stated above is then frozen.

The freezing process is preferably carried out as quick as possible. For example, during the transition from liquid state to solid state, the freezing is preferably carried out under such conditions that the solution temperature is descent at a rate of not less than 50° C./min, more preferably not less than 100° C./min.

The effect attained by rapid freezing will be described below.

When the solution is rapidly frozen, the solvent forms minute clusters as it freezes. The polymeric matrix, monomer, photoinitiator, and optionally added plasticizers, sensitizing dyes, inhibitors, and chain transfer agents dissolved in the solution are precipitated outside of the clusters of the solvent. The components precipitate along the clusters. This results in the formation of a state as if the monomer, photoinitiator, and optionally added plasticizer, sensitizing dye, heat polymerization inhibitor, and chain transfer agent are homogeneously dispersed in the polymer. When the system is put into reduced pressure in this state to vaporize the solvent, voids are formed at the positions of the minute clusters of the solvent as the it vaporizes. Consequently, a solid containing the monomer, photoinitiator, and optionally added plasticizer, sensitizing dye, inhibitor, and chain transfer agent homogeneously dispersed therein is formed.

On the other hand, when freezing is not carried out rapidly, crystals of the solvent having large domains are formed within the solution. The polymeric matrix, monomer, photoinitiator, and optionally added plasticizers, sensitizing dyes, inhibitors, and chain transfer agents are precipitated outside of the frozen solvent. The components precipitate along the crystals. When the resultant frozen solid is put under reduced pressure to vaporize the solvent, it is likely that the polymeric matrix, monomer, photoinitiator, and other components and the like are unevenly distributed.

The solution may be rapidly frozen by any method. Preferable methods include, for example, a method in which the solution is spread on to a metal substrate that had been cooled to a temperature at or below the freezing point of the solution, or a method in which the solution is sprayed into a chamber where the temperature is at or below the freezing point of the solution. Since the solvent is sublimated under reduced pressure from solid state, the latter method is preferred because the total surface area is larger. In order to freeze the solution quickly, the solution is preferably cooled to a temperature at or around the freezing point of the solution before it is put to freeze.

When gas (preferably an inert gas) is dissolved in the solution in advance, upon discharge of the solution through a spray nozzle into the chamber, foams are formed in the solution and this breaks the liquid droplets into even smaller droplets. Miniaturizing the droplets increases the freezing speed.

In the “solution freezing” process conducted in the present invention, precipitation of the components, evaporation of the solvent upon spraying the solution into the cooled chamber, particularly an reduced-pressured chamber, is carried out. The components here implies to, for example, a polymer, a monomer, a photoinitiator and the like. Solvent here mainly implies to the first solvent and the evaporation of the solvent could occur before, after or even during the solution freezing process. Therefore, the expression “freezing the solution” in the present invention does not merely refer to the case where only the solvent that constitutes the solution is frozen.

When the solid obtained by the method above is placed under reduced-pressure, only the solvent is removed from the solid. This would bring about the formation of a solid where the monomer, photoinitiator, and optionally added plasticizers, sensitizing dyes, inhibitors, and chain transfer agents are well-dispersed as in a solution state. The reduced-pressure stated above is ideally vacuum, although, the degree of the vacuum and the temperature could be adjusted as long as the drying of the solid (that is the removal of the first solvent) is satisfactory. The degree of vacuum and the temperature varies, depending on the sublimation pressure of the first solvent, temperature and the drying time.

By following the first embodiment of the present invention, a powdery photosensitive material having a residual solvent content of not more than 10 ppm, particularly of not more than 5 ppm, can easily be made.

In this powdery photosensitive material, each of the components that constitutes the photosensitive material is dispersed evenly, densely, and finely without uneven distribution. Because of such reason, this powdery photosensitive material is particularly useful as various photosensitive materials such as materials for photosensitive material that constitutes a recording layer in an optical recording medium.

### PRODUCTION PROCESS

### Second Embodiment

In the first embodiment of the present invention, the freezing of the solution in the production process of a powdery photosensitive material may be carried out under copresence of a second solvent which had been mixed in the solution before the freezing process.

This method can be regarded as one of the preferred embodiments of the first embodiment to manufacture a powdery photosensitive material. However, since a second solvent, which is different from the first solvent, is used, this method is regarded herein as the second production process (second embodiment) of a powdery photosensitive material.

In the second embodiment of the manufacturing process of a powdery photosensitive material according to the present invention, the components that constitute the photosensitive material (that is, a polymer component, an initiator component and a monomer component, and other components) are dissolved in a first solvent to provide a homogeneous solution, as with the first embodiment.

Here, the concentration of the solution in which each of the components are dissolved is preferably to be as low as possible so that the components are homogeneously dispersed as will described later. However, when the concentration of the solution is excessively low, the amount of the solvent necessary gets very large. In such a case, the cost for the solvent and the energy to remove the solvent increases. For such reasons, the amount of the polymer component (dried state) dissolved in the solvent is preferably not less than 0.01% by weight and not more than 1% by weight, more preferably not less than 0.01% by weight and not more than 0.5% by weight.

In the second embodiment of the powdery photosensitive material according to the present invention, the solution is then frozen in the copresence of a second solvent which had been mixed into the solution before the freezing process.

The second solvent preferably satisfies at least one of the following requirements (i) to (iv). It is even more preferable to satisfy two or more of the requirements.

(i) The solubility of the components that constitutes the photosensitive material to the second solvent is lower than that to the first solvent. Preferred examples of such solvents include n-hexane, n-heptane, toluene, ethyl ether, methanol, and ethanol.

(ii) The freezing point of the second solvent is lower than that of the first solvent. Preferred examples of such solvents include iso-pentane, n-pentane, n-propyl ether, and ethyl ether.

(iii) The vapor pressure of the second solvent is higher than that of the first solvent. Preferred examples of such solvents include iso-pentane, ethyl ether, n-pentene, methylene chloride, acetone, and chloroform.

(iv) The second solvent has a good compatibility with the first solvent. Preferred examples of such solvents include tetrahydrofuran and acetone.

It is preferable that the solubility of the components that constitutes the photosensitive material to the second solvent is to be as low as possible. In the second embodiment to manufacture the powdery photosensitive material according to the present invention, the second solvent is vaporized before the first solvent. Therefore, if the second solvent dissolves the components that constitutes the photosensitive material well, the components in the second solvent inhibits the vaporiazation of the second solvent. Furthermore, the components that constitutes the photosensitive material are unevenly distributed at a high concentration in the second solvent in a mixed solution composed of the second solvent and the first solvent. This disables the idea of the present invention. Therefore, the solubility of the components that constitutes the photosensitive material to the second solvent is 0 to 5 mg/ml, more preferably 0 to 1 mg/ml.

In the second embodiment of the powdery photosensitive material according to the present invention, it is preferable that the second solvent has a lower freezing point than that of the first solvent. This is because the second solvent is vaporized before the first solvent. If the freezing point of the second solvent is higher than that of the first solvent, the first solvent may freeze by the nature of the surrounding environment, or by the heat of vaporization of the second solvent. Preferably, the freezing point of the second solvent is at least 1° C., more preferably, at least 20° C., below the freezing point of the first solvent.

In the second embodiment to manufacture the powdery photosensitive material according to the present invention, it is preferable that the second solvent has a higher vapor pressure than that of the first solvent. This is because the second solvent is evaporated preferentially rather than the first solvent. When the vapor pressure of the second solvent is lower than that of the first solvent, there is a possibility that the first solvent is vaporized preferentially rather than the second solvent. Preferably, the vapor pressure of the second solvent is at least 1 hPa, more preferably at least 20 hPa higher than that of the first solvent.

Specific examples of such second solvents include ethyl methyl ketone, acetone, methanol, ethanol, n-propyl alcohol, isopropyl alcohol, ethyl ether, isopropyl ether, ethyl acetate, tetrahydrofuran, n-pentane, iso-pentane, n-hexane, toluene, methylene chloride, chloroform, and triethylamine. Specific examples of particularly preferred second solvents include iso-pentane, ethyl ether, n-hexane, and acetone. These solvents each may be used either solely or in a combination of two or more. The amount of the second solvent used is preferably 1 to 500%, particularly preferably 1 to 20%, in terms of volume ratio to the first solvent.

In the second embodiment to manufacture the powdery photosensitive material according to the present invention, the solution is frozen in the copresence of a second solvent which had been mixed into the solution before freezing. Accordingly, a part or the whole of the heat generated in the vaporization of the second solvent can be utilized as the cooling energy to freeze the solution. Therefore, this method is advantageous in that the freezing can be carried out very rapidly.

In the second embodiment to manufacture the powdery photosensitive material according to the present invention, the solution may be frozen by spraying the solution into a chamber cooled to a temperature at or below the freezing point of the solution. It is more preferable that the chamber is reduced-pressurized to a pressure below the atmospheric pressure.

In this case, the second solvent having a higher vapor pressure is vaporized first, and the first solvent freezes by the heat generated upon the evaporation of the second solvent. Also when the second solvent is vaporized, the solvent forms foams within the sprayed solution (mixture composed of the first solvent and the second solvent). Consequently, smaller liquid droplets are formed as the foam breaks the liquid droplets. Accordingly, the diameter of the spray nozzle may be made larger than that of the spray nozzle used in the first embodiment to manufacture the powdery photosensitive material.

Upon breaking of the original liquid droplets, only the first solvent and the polymeric matrix, monomer, photoinitiator and optionally added plasticizer, dye sensitizing agent, inhibitor, and chain transfer agent dissolved in the first solvent stay in the liquid droplets. The liquid of course freezes as the second solvent evaporate to apply the sublimation heat to the solution.

In the “solution freezing” process conducted in the present invention, precipitation of the components, evaporation of the solvent upon spraying the solution into the cooled chamber, particularly an reduced-pressured chamber, is carried out. The components here implies to, for example, a polymer, a monomer, a photoinitiator and the like. Solvent here implies to the first solvent or the second solvent and the evaporation of the solvent could occur before, after or even during the solution freezing process. Therefore, the expression “freezing the solution” in the present invention does not merely refer to the case where only the solvent that constitutes the solution is frozen.

When the solid obtained by the method above is placed under reduced-pressure, only the solvent is removed from the solid. The resulting formation of a solid is in such a state that the monomer, photoinitiator, and optionally added plasticizers, sensitizing dyes, inhibitors, and chain transfer agents are well-dispersed as in a solution state. The reduced-pressure stated above is ideally vacuum, although, the degree of the vacuum and the temperature could be adjusted as long as the drying of the solid (that is the removal of the first solvent) is satisfactory. The degree of vacuum and the temperature varies, depending on the sublimation pressure of the first solvent, temperature and the drying time.

According to the manufacturing process stated above, a powdery photosensitive material having a residual solvent content of not more than 10 ppm, particularly of not more than ppm, can easily be made.

In this powdery photosensitive material, the components that constitutes the photosensitive material are dispersed evenly, densely, and finely without uneven distribution, and, thus, the powdery photosensitive material is particularly useful as various photosensitive materials, for example, preferably as materials for the formation of a photosensitive material for that constitutes a recording layer in an optical recording medium.

<Optical Recording Medium>

The optical recording medium according to the present invention is formed from the powdery photosensitive material stated above.

As described above, in the powdery photosensitive material according to the present invention, the components that constitutes the photosensitive material are dispersed evenly, densely and finely without uneven distribution.

The optical recording medium according to the present invention is preferably produced by pressing the powdery photosensitive material.

Pressing machine is the favorable method to manufacture an optical recording medium when the powdery photosensitive material is press molded. The powdery photosensitive material is set in a mold in such an amount to provide the desired film thickness after it had been pressed. After the powdery photosensitive material is set in a mold, the photosensitive material is flattened to an even thickness. The processes are preferably carried out at a temperature at or below the glass transition temperature of the powdery photosensitive material from the viewpoint of handling.

After the powdery photosensitive material is densely spread flat within the mold, the powdery photosensitive material is pressed by a stamper. It is preferable that the temperature is raised to a temperature at or above the glass transition temperature of the powdery photosensitive material. It is more preferable that, the powdery photosensitive material is pressed at a temperature of at least 20° C. above the glass transition temperature of the powdery photosensitive material. The temperature may be even higher to melt the powdery photosensitive composition within the mold. Furthermore, it is preferable to press powdery photosensitive material under reduced pressure. This is to make the removal of foams easier. The pressing pressure and the pressing time are determined depending upon the properties of the powdery photosensitive material.

The recording layer in the optical recording medium is formed by the method stated above. An optical recording medium is prepared by sandwiching the recording layer manufactured by the processes described above with conventional transparent substrates. The substrate is formed of glass or plastic.

In the powdery photosensitive material according to the present invention, the components that constitutes the photosensitive material are dispersed evenly, densely and finely without uneven distribution.

By virtue of the advantage stated above, the photosensitive layer formed of the photosensitive material obtained from the powdery photosensitive material according to the present invention, variation in properties is small even when the area and thickness of the photosensitive material are large. This enables the photosensitive material to react without fluctuation from position to position. Therefore, the powdery photosensitive material is particularly suitable for photosensitive material, such as the recording layer in optical recoding media.

Furthermore, the powdery photosensitive material according to the invention is also advantageous in that it can be molded to form a molded product in a short time by means of press molding and the like.

In particular, since the photosensitive material to be pressed is powdery and has a very low residual solvent content volume shrinkage that derives from the evaporation of the solvent does not occur. This enables to fabricate a molded product to a desired shape. The thickness and surface flatness of the molded product can easily be provided with accuracy and within a short time.

In the recording layer containing the components stated above, the light transmittance of the recording light is preferably 10% to 95%, more preferably 20% to 90%. Having the light transmittance over or 10%, essential sensitivity and diffraction efficiency can be achieved. Having the light transmittance below or 95% scattering of the recording light beam can be avoided and enables to record the information accurately.

### EXAMPLES

### Example 1

The experiment was done under absence of light. Polybutyl methacrylate (7.5 g) was added to 1000 ml of 1,4-dioxane, and 0.9 g of vinylcarbazole and 0.04 g of Irgacure 784 were further added to and dissolved therein. The solution was stirred and cooled in a water bath cooled at 10° C. After thorough cooling, the cooled solution was sprayed into a round-bottom flask which had been previously cooled with liquid nitrogen.

The solution instantly froze as the solution was sprayed into the flask and the resultant solid was sedimented on the bottom of the flask. After the spraying process, the flask was connected to a vacuum pump, and the flask was put to vacuo. The frozen solution was freeze-dried while the flask was gradually let to warm to ambient temperature. After 5 hr of the freeze-drying process, the amount of dioxane flown into the trap of the vacuum pump remained unchanged, and the drying was put to halt to yield a powdery photosensitive material having a residual solvent content of not more than 10 ppm.

0.5 g of the powder thus obtained was pressed with a pressing machine at room temperature to form a transparent recording layer. This recording layer was held between two glass substrates, and the assembly was further pressed to give a specimen. A hologram was recorded to the specimen by a two-beam interference method, and it was then evaluated. The specimen showed steady holographic properties, indicating that this specimen was a good holographic recorded medium.

### Example 2

Into 100 g of the solution prepared in Example 1, 5 g of hexane was added. The solution was stirred and cooled in a water bath. After sufficient cooling, the cooled solution was slowly sprayed into a two-necked round-bottom flask, which had been cooled in dry ice and put in vacuo by a vacuum pump. The solution instantly froze as it was sprayed into the flask and the resultant solid was sedimented on to the surface of the flask. The flask was continuously put to vacuo by the vacuum pump to freeze-dry to yield a powdery photosensitive material having a residual solvent content of not more than 10 ppm.

0.3 g of the powder thus obtained was pressed with a pressing machine at room temperature to form a transparent recording layer. This recording layer was held between two glass substrates, and the assembly was further pressed to give a specimen. A hologram was recording to the specimen by a two-beam interference method, and it was then evaluated. Like the case of Example 1, the specimen showed steady holographic properties, indicating that this specimen was a good holographic recorded medium.

### Comparative Example 1

The solution prepared in Example 1 was spread on a glass substrate heated on a hot plate, and was allowed to dry. The coated substrate was dried in vacuo overnight to remove the solvent completely. The recording layer was covered with a glass substrate to give a comparative specimen.

A hologram was recorded to the comparative specimen by a two-beam reference method. The results were not significantly reproducible and gave large fluctuation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A process for manufacturing a powdery photosensitive material, comprising: freezing a solution of components for the photosensitive material dissolved in a first solvent thereby obtaining a solid composition; and drying the solid composition under reduced-pressure to obtain a powdery photosensitive material.

2. The process according to claim 1, wherein the freezing of the solution is carried out by spraying the solution into a chamber cooled to a temperature of or below the freezing point of the solution.

3. The process according to claim 1, wherein the first solvent has a freezing point in the range of −100° C. to +100° C.

4. The process according to claim 1, wherein the first solvent is selected from the group consisting of water, acetamide, trioxane, acetic acid, p-xylene, 1,4-dioxane, 2-aminoethanol, formic acid, cyclohexane, benzene, morpholine, aniline, nitromethane, piperidine, nitromethane, anisole, pyridine, and acetonitrile.

5. The process according to claim 1, wherein the components that constitutes the photosensitive material are a polymer, a photoinitiator, and a monomer.

6. The process according to claim 1, wherein the freezing of the solution is carried out in the copresence of a second solvent which are mixed into the solution before the freezing process.

7. The process according to claim 6, wherein the freezing of the solution is carried out using the heat of vaporization of the second solvent.

8. The process according to claim 6, wherein the solubility of the components that constitutes the photosensitive material to the second solvent is lower than that of the first solvent.

9. The process according to claim 6, wherein the second solvent has a freezing point below the first solvent.

10. The process according to claim 6, wherein the second solvent has a vapor pressure above the first solvent.

11. A powdery photosensitive material produced by a process according to claim 1 wherein the content of the remaining solvent in the powdery photosensitive material is 10 ppm or less.

12. An optical recording medium produced from the powdery photosensitive material according to claim 11.

13. An optical recording medium produced by press molding the powdery photosensitive material according to claim 11.

14. An optical recording medium produced by press molding the powdery photosensitive material according to claim 11 at or above the glass transition temperature of the photosensitive material.
